(19) United States
(12) Patent Application Publication
(10) Pub. No.: US 2025/0282457 A1
(43) Pub. Date: Sep. 11, 2025

(54) NAVIGATION ASSISTANCE SYSTEM, NAVIGATION ASSISTANCE DEVICE, AND NAVIGATION ASSISTANCE METHOD

(71) Applicant: Furuno Electric Co., Ltd., Nishinomiya (JP)

(72) Inventor: Jun YAMABAYASHI, Osakasayama-shi (JP)

(21) Appl. No.: 19/217,875

(22) Filed: May 23, 2025

Related U.S. Application Data
(63) Continuation of application No. PCT/JP2023/039615, filed on Nov. 2, 2023.

(30) Foreign Application Priority Data
Dec. 1, 2022 (JP) 2022-192861

(51) Int. Cl. B63B 49/00; G08G 3/02

(52) U.S. Cl. CPC B63B 49/00; G08G 3/02

(57) ABSTRACT

A navigation assistance system includes a navigation assistance device installed on a ship and a remote monitoring device installed outside the ship. The navigation assistance device includes processing circuitry configured to: acquire navigation-related data related to navigation of the ship; calculate an assistance necessity level indicating a degree to which the ship requires assistance from outside, based on the navigation-related data; and transmit the assistance necessity level to outside of the ship. The remote monitoring device includes processing circuitry configured to receive the assistance necessity level transmitted by the navigation assistance device.

### CROSS-REFERENCE TO RELATED APPLICATION

The present application is a continuation of PCT/JP2023/039615, filed on Nov. 2, 2023, and is related to and claims priority from Japanese patent application no. 2022-192861, filed on Dec. 1, 2022. The entire contents of the aforementioned application are hereby incorporated by reference herein.

### BACKGROUND

### Technical Field

The disclosure relates to a navigation assistance system, a navigation assistance device, a navigation assistance method, and a program.

### Conventional Art

Conventional Art discloses a navigation communication assistance device between ships that enables one's own ship and another ship encountered at sea to convey ship operation intentions to avoid collision.

In recent years, techniques for remotely assisting ships having reduced manpower, such as manned autonomous ships, have been researched.

### SUMMARY

A navigation assistance system of an aspect of the disclosure includes a navigation assistance device installed on a ship and a remote monitoring device installed outside the ship. The navigation assistance device includes an acquiring unit, a calculating unit, and a transmitting unit. The acquiring unit is configured to acquire navigation-related data related to navigation of the ship. The calculating unit is configured to calculate an assistance necessity level indicating a degree to which the ship requires assistance from outside, based on the navigation-related data. The transmitting unit is configured to transmit the assistance necessity level to outside of the ship. The remote monitoring device includes a receiving unit configured to receive the assistance necessity level transmitted by the navigation assistance device. Accordingly, it becomes possible to facilitate assisting the ship from outside.

In the above aspect, the transmitting unit of the navigation assistance device may be further configured to transmit the navigation-related data at a particular frequency. Accordingly, it becomes possible to share the navigation-related data.

In the above aspect, the remote monitoring device may further include a displaying unit, a generating unit, and a transmitting unit. The displaying unit is configured to display the navigation-related data transmitted by the navigation assistance device. The generating unit is configured to generate assistance data for assisting navigation of the ship in response to an operation input performed by a user. The transmitting unit is configured to transmit the assistance data to the navigation assistance device. Accordingly, it becomes possible to provide the assistance data to the ship.

In the above aspect, the transmitting unit of the navigation assistance device may be configured to change a frequency at which the navigation-related data is transmitted according to the assistance necessity level. Accordingly, it becomes possible to transmit the navigation-related data at a frequency corresponding to the assistance necessity level.

In the above aspect, the transmitting unit of the navigation assistance device may be configured to transmit, to the remote monitoring device, the navigation-related data that has not been transmitted in the past, in a case where communication at a particular speed or higher is established between the navigation assistance device and the remote monitoring device. Accordingly, it becomes possible to share the navigation-related data that has not been transmitted in the past.

In the above aspect, the remote monitoring device may further include a calculating unit configured to calculate a relative assistance necessity level for multiple ships based on the navigation-related data transmitted from the multiple ships. Accordingly, it becomes possible to calculate the relative assistance necessity level.

In the above aspect, the remote monitoring device may further include a notifying unit configured to notify each of the multiple ships of the relative assistance necessity level. Accordingly, it becomes possible to notify the relative assistance necessity level.

In the above aspect, the remote monitoring device may further include a displaying unit configured to display a symbol of the ship, and the displaying unit may be configured to change at least one of a display mode and a selected state of the symbol according to the assistance necessity level transmitted by the navigation assistance device. Accordingly, it becomes possible to realize display of the symbol corresponding to the assistance necessity level.

In addition, a navigation assistance device of another aspect of the disclosure includes an acquiring unit, a calculating unit, and a transmitting unit. The acquiring unit is configured to acquire navigation-related data related to navigation of a ship. The calculating unit is configured to calculate an assistance necessity level indicating a degree to which the ship requires assistance from outside, based on the navigation-related data. The transmitting unit is configured to transmit the assistance necessity level to outside of the ship. Accordingly, it becomes possible to facilitate assisting the ship from outside.

In addition, a navigation assistance method of another aspect of the disclosure includes: acquiring navigation-related data related to navigation of a ship; calculating an assistance necessity level indicating a degree to which the ship requires assistance from outside, based on the navigation-related data; and transmitting the assistance necessity level to outside of the ship. Accordingly, it becomes possible to facilitate assisting the ship from outside.

In addition, a program of another aspect of the disclosure causes a computer to execute processing configured to: acquire navigation-related data related to navigation of a ship; calculate an assistance necessity level indicating a degree to which the ship requires assistance from outside, based on the navigation-related data; and transmit the assistance necessity level to outside of the ship. Accordingly, it becomes possible to facilitate assisting the ship from outside.

### BRIEF DESCRIPTION OF THE DRAWINGS

FIG. 1 is a view showing an example of a navigation assistance system.

FIG. 2 is a view showing an example of an onboard system.

FIG. 3 is a view showing an example of a remote monitoring device.

FIG. 4 is a view showing a display example of a monitoring screen.

FIG. 5 is a view showing another display example of a monitoring screen.

FIG. 6 is a view showing a configuration example of a ship information sharing device.

FIG. 7 is a view for describing calculation of an assistance necessity level.

FIG. 8 is a view for describing watchkeeping capability data.

FIG. 9 is a view showing a configuration example of a remote monitoring device.

FIG. 10 is a view showing a procedure example of a navigation assistance method.

FIG. 11 is a view for describing change of a transmission frequency.

FIG. 12 is a view for describing transfer of unsent data.

FIG. 13 is a view showing a configuration example of a remote monitoring device.

FIG. 14 is a view showing a procedure example of a navigation assistance method.

### DESCRIPTION OF THE EMBODIMENTS

Embodiments of the disclosure relate to a navigation assistance system, a navigation assistance device, a navigation assistance method, and a program capable of facilitating assisting a ship from outside.

Hereinafter, embodiments of the disclosure will be described with reference to the drawings.

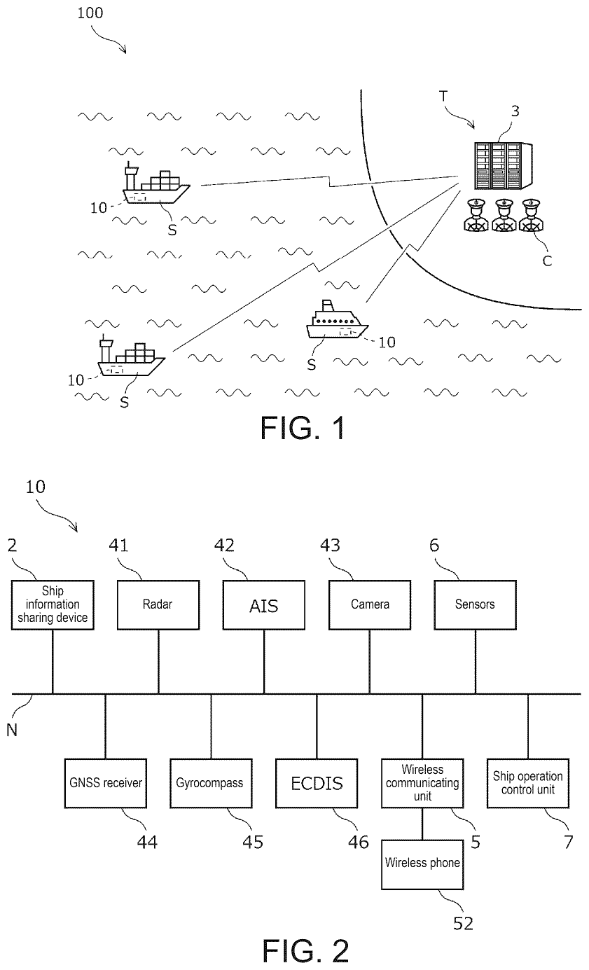

FIG. 1 is a view showing an example of a navigation assistance system 100. The figure schematically shows multiple ships S navigating at sea and a land center T. The navigation assistance system 100 includes an onboard system 10 installed on the ship S and a remote monitoring device 3 installed at the land center T.

The onboard system 10 and the remote monitoring device 3 are capable of communicating with each other via, for example, satellite communication. Not limited to satellite communication, wireless communication using, for example, ultra high frequency, very high frequency, high frequency, medium-high frequency, or medium frequency may also be adopted.

The onboard system 10 sequentially transmits navigation-related data related to navigation of the ship S to the remote monitoring device 3. The remote monitoring device 3 collects the navigation-related data transmitted from the onboard system 10 and uses the navigation-related data for monitoring and assistance of the ship S.

The ship S is, for example, a ship with reduced manpower such as a manned autonomous ship. Thus, the ship S may require assistance from outside. Reduction of manpower on a ship refers to having fewer crew members compared to the typical number of crew members on a ship of the same size. It is also possible that the ship S is not an autonomous ship.

A land captain C is stationed at the land center T. The land captain C is, for example, land-based assistance staff who has qualifications or skills of a ship captain or an equivalent thereto. The land captain C performs monitoring and assistance of the ship S using the remote monitoring device 3.

With introduction of the navigation assistance system 100, it becomes possible to save manpower on the ship S while still ensuring safety. In other words, by receiving assistance from the land captain C, it becomes possible for even a less experienced navigator to navigate the ship S like a skilled captain.

FIG. 2 is a block diagram showing a configuration example of the onboard system 10. The onboard system 10 is a system installed on the ship S. In the following description, from the viewpoint of the onboard system 10, the ship on which the system is installed is referred to as an “own ship”, and other ships are referred to as “other ships”.

The onboard system 10 includes a ship information sharing device 2, a radar 41, an AIS 42, a camera 43, a GNSS receiver 44, a gyrocompass 45, an ECDIS 46, a wireless communicating unit 5, sensors 6, and a ship operation control unit 7. These devices are connected to a network N such as a LAN, and are capable of performing network communication with each other.

The ship information sharing device 2 is a computer including a CPU, a RAM, a ROM, a non-volatile memory, and an input and output interface. The CPU of the ship information sharing device 2 executes information processing according to a program loaded from the ROM or the non-volatile memory into the RAM.

The program may be supplied via an information storage medium such as an optical disc or a memory card, or may be supplied via a communication network such as the Internet or the LAN.

The radar 41 emits radio waves around the own ship, receives reflections thereof, and generates echo data based on the received signals. In addition, the radar 41 identifies a target from the echo data and generates TT (target tracking) data indicating the position and the speed of the target.

The AIS (Automatic Identification System) 42 receives AIS data from other ships present around the own ship or from land-based control stations. Not limited to the AIS, a VDES (VHF Data Exchange System) may also be used. The AIS data includes identification codes, ship names, positions, courses, speeds, ship types, hull lengths, destinations, etc. of other ships.

The camera 43 is a digital camera that captures images of outside from the own ship to generate image data. The camera 43 is, for example, disposed on the bridge of the own ship and oriented toward the heading. The camera 43 is, for example, a so-called PTZ camera with a pan-tilt function and an optical zoom function.

In addition, the camera 43 may include an image recognizing unit that estimates an in-image position and a type of the target such as a ship included in the captured image according to an object detection model. The image recognizing unit is not limited to the camera 43, and may also be realized in other devices such as the ship information sharing device 2.

The GNSS receiver 44 detects the position of the own ship based on radio waves received from the GNSS (Global Navigation Satellite System). The gyrocompass 45 detects the heading of the own ship. Not limited to the gyrocompass, a GPS compass may also be used.

The ECDIS (Electronic Chart Display and Information System) 8 acquires the position of the own ship from the GNSS receiver 44 and displays the position of the own ship on an electronic chart. In addition, the ECDIS 46 also displays a scheduled route of the own ship on the electronic chart. Not limited to the ECDIS, a GNSS plotter may also be used.

The wireless communicating unit 5 includes wireless equipment that realizes satellite communication. In addition, the wireless communicating unit 5 includes wireless equipment that realizes wireless communication using, for example, ultra high frequency, very high frequency, high frequency, medium-high frequency, or medium frequency. The wireless communicating unit 5 includes a wireless phone 52 that realizes phone communication between ships.

The sensors 6 include, for example, a gyro sensor that detects the attitude of the own ship. In addition, the sensors 6 include various sensors that detect the state of equipment such as the engine of the own ship.

The ship operation control unit 7 is a control device for realizing autonomous navigation and controls the steering gear of the own ship. The ship operation control unit 7 may also control the engine of the own ship in addition to the steering gear of the own ship.

In this embodiment, the ship information sharing device 2 is an independent device, but is not limited thereto and may also be integrated with other devices such as the ECDIS 46. In other words, the functional units of the ship information sharing device 2 may also be realized in other devices.

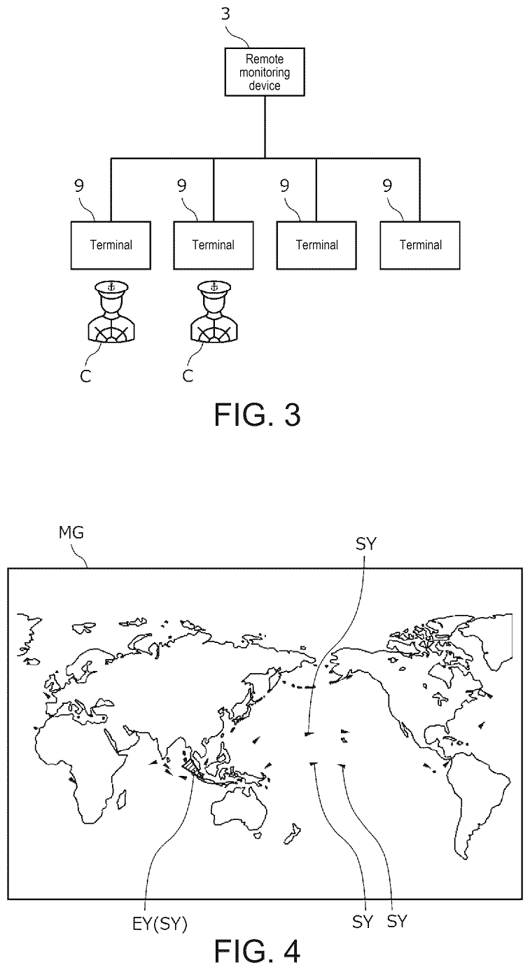

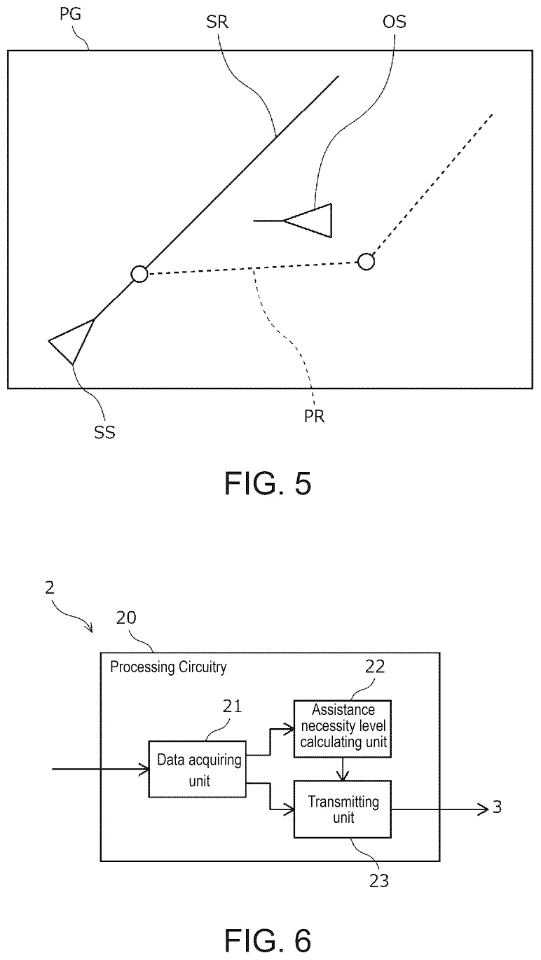

FIG. 3 is a block diagram showing a configuration example of the remote monitoring device 3. The remote monitoring device 3 is also a computer including a CPU, a RAM, a ROM, a non-volatile memory, and an input and output interface. Multiple terminals 9 are connected to the remote monitoring device 3, and a part or all of the terminals 9 are used by the land captain C. FIG. 4 and FIG. 5 are views showing display examples of monitoring screens displayed on the terminals 9. A monitoring screen MG shown in FIG. 4 is, for example, an electronic chart on which multiple symbols SY representing multiple ships S are mapped to in-image positions corresponding to actual positions.

A monitoring screen PG shown in FIG. 5 is an enlarged screen of an area including a symbol SS representing a monitored ship and a symbol OS representing another ship present around the monitored ship. In addition, a scheduled route SR along which the monitored ship is scheduled to navigate is drawn on the monitoring screen PG.

In addition, an avoidance proposal route PR inputted by the land captain C on the terminal 9 is also drawn on the monitoring screen PG. The data of the avoidance proposal route PR is transmitted to the monitored ship as assistance data and is displayed, for example, on a display device onboard the ship.

In the navigation assistance system 100, the land captain C is expected to monitor numerous ships S using the remote monitoring device 3, but it is difficult to determine which ships S require assistance.

Thus, in this embodiment, as will be described below, navigation assistance is facilitated by defining an assistance necessity level indicating a degree to which a ship S requires assistance from outside.

Hereinafter, a first embodiment will be described. FIG. 6 is a block diagram showing a configuration example of the ship information sharing device 2. In the first embodiment, the ship information sharing device 2 is an example of a navigation assistance device that calculates an assistance necessity level.

Processing circuitry 20 of the ship information sharing device 2 includes a data acquiring unit 21, an assistance necessity level calculating unit 22, and a transmitting unit 23. These functional units are realized by the CPU of the processing circuitry 20 executing information processing according to a program.

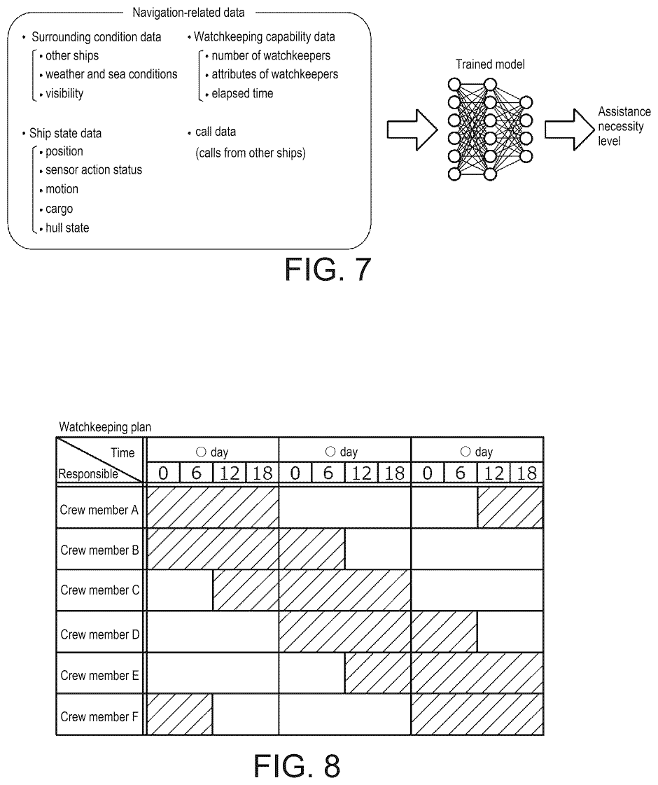

The data acquiring unit 21 acquires navigation-related data related to navigation of the own ship. The navigation-related data includes, for example, surrounding condition data indicating the condition around the own ship, ship state data indicating the state of the own ship, watchkeeping capability data indicating the watchkeeping capability of the own ship, or call data indicating calls from other ships via the wireless phone (refer to FIG. 7).

The surrounding condition data includes, for example, the positions of other ships detected by the radar 41 or the AIS 42. The surrounding condition data may further include the speed (ship speed and course) of other ships. In other words, TT data generated by the radar 41 or AIS data received by the AIS 42 are examples of the surrounding condition data.

In addition, the surrounding condition data may include meteorological and oceanographic data indicating the weather and sea conditions around the own ship. The meteorological and oceanographic data is acquired from an external server via the wireless communicating unit 5. In addition, the surrounding condition data may include data indicating the degree of visibility around the own ship. The degree of visibility is determined from images captured by the camera 43.

The ship state data includes, for example, the position of the own ship detected by the GNSS receiver 44. In addition, the ship state data may include data indicating the action status of sensors disposed at equipment such as the engine of the own ship, or data indicating the degree of motion of the own ship detected by a gyro sensor.

Furthermore, the ship state data may include data indicating the amount of cargo on the own ship, or data indicating the hull state of the own ship. The hull state is, for example, the amount of ballast, or the amount of barnacles attached to the ship's bottom. These data are, for example, stored in the memory in advance according to input from a user and are read out during use.

The watchkeeping capability data is data indicating the watchkeeping capability of the own ship at the time point of calculating the assistance necessity level, and includes, for example, the number of watchkeepers on the own ship, attributes of the watchkeepers on the own ship, or the elapsed time from start of watchkeeping.

Specifically, the number of watchkeepers is the number of people performing watchkeeping at the time point of calculating the assistance necessity level. The attributes of the watchkeepers are, for example, ranks, qualifications, or years of experience. The elapsed time from start of watchkeeping is the elapsed time from when the watchkeeper starts watchkeeping until the time point of calculating the assistance necessity level.

The watchkeeping capability data is acquired, for example, from a watchkeeping plan table as shown in FIG. 8. The watchkeeping plan table specifies the time at which each crew member is responsible for watchkeeping, and it is possible to read the number of watchkeepers, the attributes of watchkeepers, or the elapsed time from start of watchkeeping at each time point.

The call data is generated by the wireless communicating unit 5 in the case of a call from another ship to the wireless phone 52.

The assistance necessity level calculating unit 22 calculates an assistance necessity level indicating the degree to which the own ship requires assistance from outside, based on the navigation-related data acquired by the data acquiring unit 21. In other words, the assistance necessity level calculating unit 22 comprehensively calculates the assistance necessity level based on the surrounding condition data, the ship state data, the watchkeeping capability data, or the call data.

The assistance necessity level calculating unit 22 estimates the assistance necessity level from the navigation-related data acquired by the data acquiring unit 21 using a trained model generated in advance by machine learning (refer to FIG. 7). The assistance necessity level calculating unit 22 is not limited thereto, and may also calculate the assistance necessity level from the watchkeeping capability data according to a particular rule.

The trained model is generated by machine learning, taking navigation-related data for learning as input data and taking an assistance necessity level for learning associated with the navigation-related data for learning as teacher data. The trained model is, for example, composed of a deep neural network.

The assistance necessity level for learning associated with the navigation-related data for learning is a label indicating whether assistance is required in a binary form. The assistance necessity level for learning may be assigned based on an evaluation by experienced marine technicians, for example.

The output layer of the trained model is configured to output a numerical value of 0 or more and 1 or less according to a sigmoid function. The assistance necessity level is indicated, for example, as a numerical value of 0 or more and 100 or less, based on the numerical value outputted from the trained model.

For example, the assistance necessity level is calculated to be higher in the case where the position of the own ship detected by the GNSS receiver 44 is in a particular sea area such as the Strait of Malacca. In addition, the assistance necessity level is calculated to be higher in the case where the surroundings of the own ship are rainy or the waves are high.

In addition, the assistance necessity level is calculated to be higher as the visibility determined from the image captured by the camera 43 becomes worse. In addition, the assistance necessity level is calculated to be higher as the number of other ships detected by the radar 41 or the AIS 42 is larger.

In addition, the assistance necessity level is calculated to be higher in the case where there is a call from another ship to the wireless phone 52. In addition, the assistance necessity level is calculated to be higher in the case where there is a malfunction in the action status of the sensors of the own ship or in the case where the motion of the own ship is large.

In addition, the assistance necessity level is calculated to be higher as the watchkeeping capability of the own ship is lower. For example, the assistance necessity level becomes higher as the number of watchkeepers decreases, as their rank are lower, as their years of experience are shorter, or as the elapsed time from start of watchkeeping becomes longer.

The transmitting unit 23 transmits the assistance necessity level calculated by the assistance necessity level calculating unit 22 to the remote monitoring device 3. In addition, the transmitting unit 23 transmits the navigation-related data acquired by the data acquiring unit 21 to the remote monitoring device 3 at a particular transmission frequency. As will be described later, the transmitting unit 23 may change the transmission frequency of the navigation-related data according to the assistance necessity level.

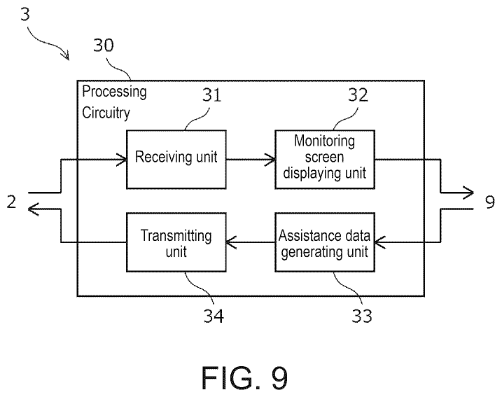

FIG. 9 is a block diagram showing a configuration example of the remote monitoring device 3. Processing circuitry 30 of the remote monitoring device 3 includes a receiving unit 31, a monitoring screen displaying unit 32, an assistance data generating unit 33, and a transmitting unit 34. These functional units are realized by the CPU of the processing circuitry 30 executing information processing according to a program.

The receiving unit 31 receives the assistance necessity level and the navigation-related data transmitted by the ship information sharing device 2.

The monitoring screen displaying unit 32 displays a screen showing the navigation-related data received by the receiving unit 31. For example, the monitoring screen displaying unit 32 generates a monitoring screen MG (refer to FIG. 4) with a symbol SY placed at an in-image position corresponding to the actual position of the ship S, and displays the monitoring screen MG on the terminal 9.

In addition, the monitoring screen displaying unit 32 may change at least one of a display mode and a selected state of the symbol SY according to the assistance necessity level received by the receiving unit 31. For example, as shown in FIG. 4, the display mode such as the shape, the color, or the size of a symbol EY, which has an assistance necessity level equal to or greater than a threshold, may be configured to be different from other symbols SY. In addition, the symbol EY having an assistance necessity level equal to or greater than the threshold may be automatically set to the selected state as a monitored target.

The assistance data generating unit 33 generates assistance data for assisting navigation of the ship S in response to an operation input performed by the land captain C. For example, as shown in FIG. 5, data of the avoidance proposal route PR inputted to the terminal 9 by the land captain C is generated as assistance data. The assistance data is not limited thereto, and may also be, for example, voice data of the land captain C or control data for ship operation control.

The transmitting unit 34 transmits the assistance data generated by the assistance data generating unit 33 to the ship information sharing device 2. For example, in the case where the data of the avoidance proposal route PR is transmitted as the assistance data, on the ship S, the avoidance proposal route PR is displayed by the ship information sharing device 2 and confirmed by the crew member.

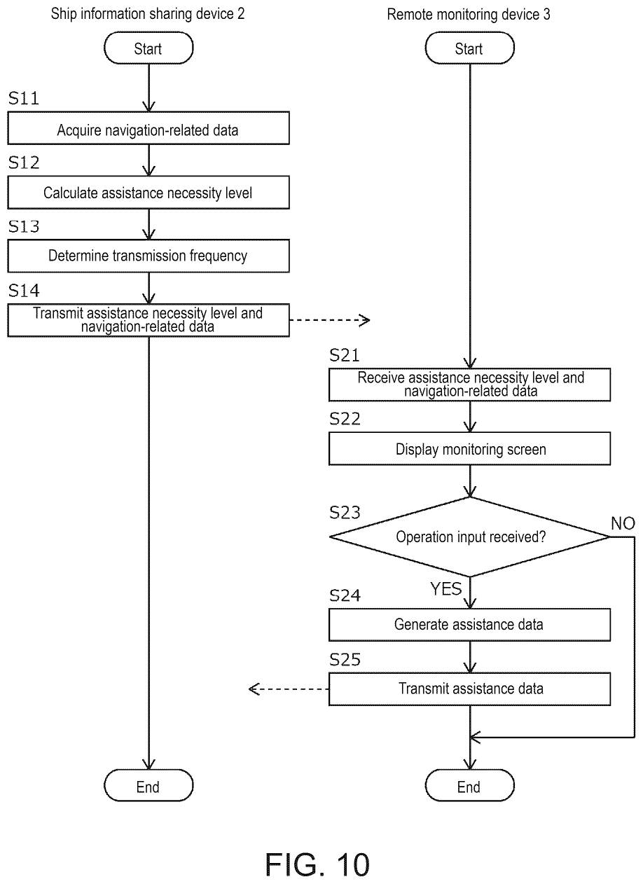

FIG. 10 is a flowchart showing a procedure example of the navigation assistance method realized in the navigation assistance system 100.

The processing circuitry 20 of the ship information sharing device 2 functions as the data acquiring unit 21, the assistance necessity level calculating unit 22, and the transmitting unit 23 described above by executing information processings S11 to S14 shown in the figure according to a program.

First, the processing circuitry 20 of the ship information sharing device 2 acquires navigation-related data of the own ship (S11, processing as the data acquiring unit 21).

Next, the processing circuitry 20 of the ship information sharing device 2 calculates an assistance necessity level of the own ship based on the navigation-related data acquired in S11 (S12, processing as the assistance necessity level calculating unit 22).

Next, the processing circuitry 20 of the ship information sharing device 2 determines a transmission frequency of the navigation-related data based on the assistance necessity level calculated in S12 (S13). The determination of the transmission frequency will be described later.

Next, the processing circuitry 20 of the ship information sharing device 2 transmits the assistance necessity level calculated in S12 and the navigation-related data acquired in S11 to the remote monitoring device 3 (S14, processing as the transmitting unit 23).

The processing circuitry 30 of the remote monitoring device 3 functions as the receiving unit 31, the monitoring screen displaying unit 32, the assistance data generating unit 33, and the transmitting unit 34 described above by executing information processings S21 to S25 shown in the figure according to a program.

First, the processing circuitry 30 of the remote monitoring device 3 receives the assistance necessity level and the navigation-related data from the ship information sharing device 2 (S21, processing as the receiving unit 31).

Next, the processing circuitry 30 of the remote monitoring device 3 displays a monitoring screen on the terminal 9 based on the assistance necessity level and the navigation-related data received in S21 (S22, processing as the monitoring screen displaying unit 32).

Next, in response to receiving an operation input from the land captain C (S23: YES), the processing circuitry 30 of the remote monitoring device 3 generates assistance data based on the operation input (S24, processing as the assistance data generating unit 33).

Next, the processing circuitry 30 of the remote monitoring device 3 transmits the assistance data generated in S24 to the ship information sharing device 2 (S25, processing as the transmitting unit 34). The transmitted assistance data is used for display and the like in the ship information sharing device 2.

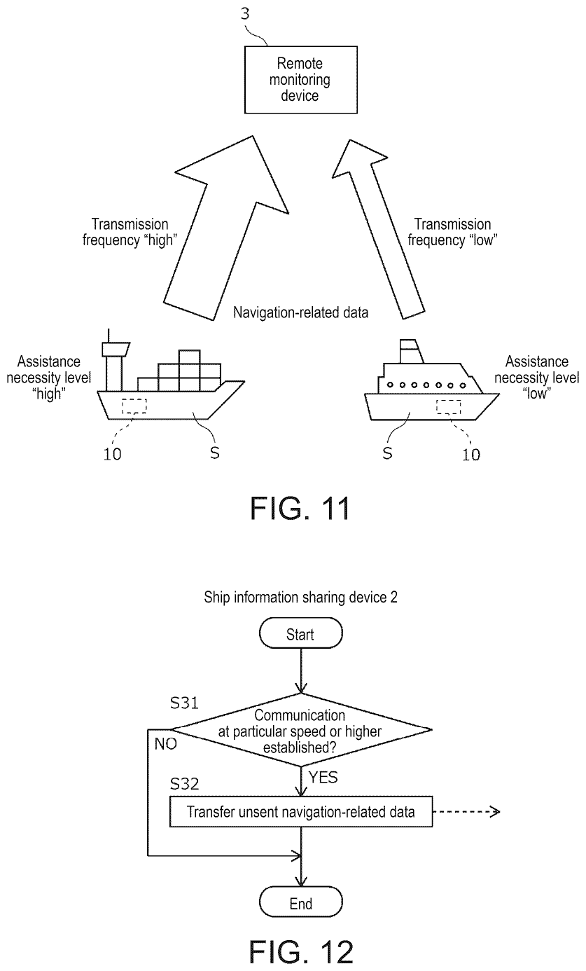

FIG. 11 is a view for describing change of the transmission frequency of the navigation-related data. The processing circuitry 20 of the ship information sharing device 2 changes the transmission frequency of the navigation-related data transmitted to the remote monitoring device 3 according to the assistance necessity level.

Specifically, the processing circuitry 20 of the ship information sharing device 2 increases the transmission frequency as the assistance necessity level increases, and decreases the transmission frequency as the assistance necessity level decreases. In other words, the processing circuitry 20 of the ship information sharing device 2 thins out the transmission of the navigation-related data as the assistance necessity level decreases.

By increasing the transmission frequency as the assistance necessity level increases, it becomes possible to provide detailed navigation-related data to the remote monitoring device 3 on land to increase the resolution of monitoring. In contrast, by decreasing the transmission frequency as the assistance necessity level decreases, it becomes possible to suppress the amount of communication data.

As a result of the decreased transmission frequency, unsent navigation-related data that has not been transmitted to the remote monitoring device 3 is stored in the memory of the ship information sharing device 2, and is transferred to the remote monitoring device 3 at another opportunity by a processing to be described next.

FIG. 12 is a flowchart for describing transfer of the unsent navigation-related data. Information processings S31 to S32 shown in the figure are executed, for example, at the time of docking of the ship S.

In the case where communication at a particular speed or higher is established between the ship information sharing device 2 and the remote monitoring device 3 (S31: YES), the processing circuitry 20 of the ship information sharing device 2 transfers the unsent navigation-related data to the remote monitoring device 3 (S32).

The case where communication at a particular speed or higher is established refers to, for example, the case where wired communication becomes possible at the time of docking of the ship S, or the case where wireless communication (e.g., wireless LAN) faster than satellite communication becomes possible.

The navigation-related data collected from multiple ships S by the remote monitoring device 3 is used for re-training of the trained model for estimating the assistance necessity level. Accordingly, it becomes possible to improve the estimation accuracy of the trained model.

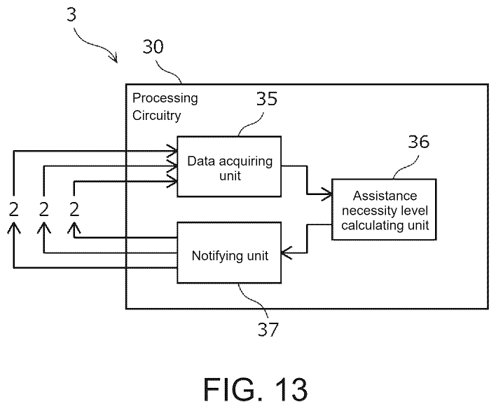

Hereinafter, a second embodiment will be described. FIG. 13 is a block diagram showing a configuration example of the remote monitoring device 3. In the second embodiment, both the ship information sharing device 2 and the remote monitoring device 3 are an example of the navigation assistance device that calculates the assistance necessity level. The embodiment is not limited thereto, and it is also possible that the remote monitoring device 3 alone calculates the assistance necessity level.

The processing circuitry 30 of the remote monitoring device 3 includes a data acquiring unit 35, an assistance necessity level calculating unit 36, and a notifying unit 37. These functional units are realized by the CPU of the processing circuitry 30 executing information processing according to a program. Along with these functional units, the receiving unit 31, the monitoring screen displaying unit 32, the assistance data generating unit 33, and the transmitting unit 34 described above are also included.

The data acquiring unit 35 acquires navigation-related data transmitted from multiple ships S. In particular, the data acquiring unit 35 acquires surrounding condition data indicating the condition around each ship S from multiple ships S. The surrounding condition data includes the positions and the speeds of other ships present around the ship S.

The assistance necessity level calculating unit 36 calculates a relative assistance necessity level for each ship S based on the navigation-related data. The relative assistance necessity level is an assistance necessity level defined based on the relationship or comparison between a target ship S and other ships S.

By aggregating the navigation-related data from multiple ships S, it becomes possible to calculate a relative assistance necessity level for each ship S. In particular, by aggregating the surrounding condition data including the positions and the speeds of other ships present around each ship S from multiple ships S, it becomes easier to determine a magnitude relationship of the assistance necessity level of multiple ships S.

The notifying unit 37 notifies each ship S of the relative assistance necessity level calculated for the corresponding ship S. Specifically, the notifying unit 37 notifies a first ship S of the assistance necessity level calculated for the first ship S, and notifies a second ship S of the assistance necessity level calculated for the second ship S.

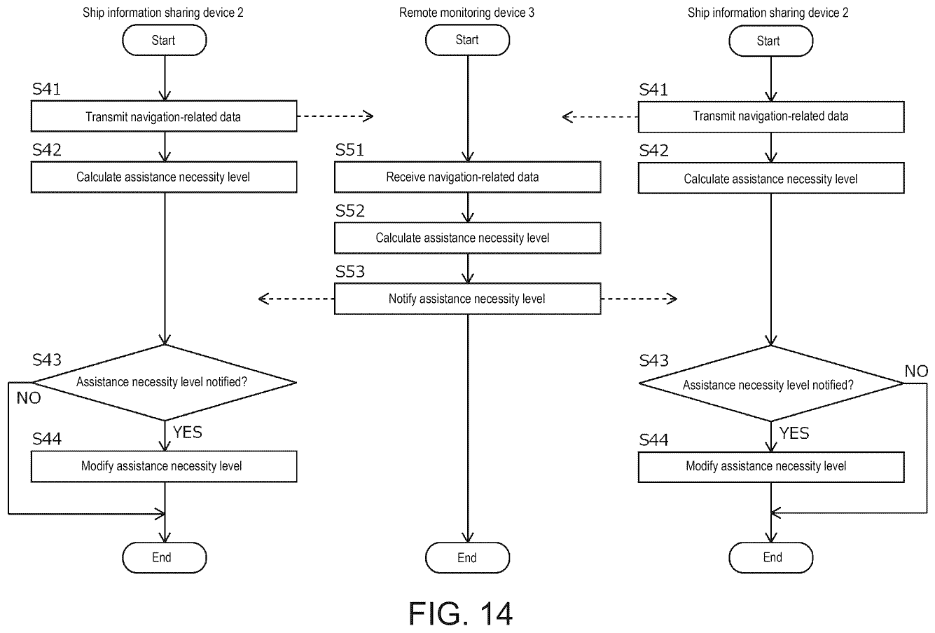

FIG. 14 is a flowchart showing a procedure example of the navigation assistance method according to the second embodiment. The processing circuitry 30 of the remote monitoring device 3 functions as the data acquiring unit 35, the assistance necessity level calculating unit 36, and the notifying unit 37 described above by executing information processings S51 to S53 shown in the figure according to a program.

The processing circuitry 20 of the ship information sharing device 2 installed on each ship S transmits navigation-related data of the own ship to the remote monitoring device 3 (S41). In addition, the processing circuitry 20 of the ship information sharing device 2 calculates an assistance necessity level of the own ship based on the navigation-related data of the own ship (S42).

Upon receiving the navigation-related data from multiple ships S (S51, processing as the data acquiring unit 35), the processing circuitry 30 of the remote monitoring device 3 calculates a relative assistance necessity level for each ship S (S52, processing as the assistance necessity level calculating unit 36), and notifies each ship S of the relative assistance necessity level (S53, processing as the notifying unit 37).

Upon being notified of the relative assistance necessity level from the remote monitoring device 3 (S43: YES), the processing circuitry 20 of the ship information sharing device 2 modifies the assistance necessity level of the own ship based on the notified relative assistance necessity level (S44).

According to the second embodiment described above, it becomes possible to calculate a relative assistance necessity level for each ship S. In addition, it also becomes possible to feed the relative assistance necessity level back to each ship S.

Although the disclosure has been described with respect to the embodiments above, the disclosure is not limited to the embodiments described above, and those skilled in the art may of course make various modifications.

The following lists representative embodiments of the disclosure.

(1)

A navigation assistance system including:
a navigation assistance device installed on a ship and including:
   an acquiring unit configured to acquire navigation-related data related to navigation of the ship;
a calculating unit configured to calculate an assistance necessity level indicating a degree to which the ship requires assistance from outside, based on the navigation-related data; and
a transmitting unit configured to transmit the assistance necessity level to outside of the ship; and
a remote monitoring device installed outside the ship and including:
a receiving unit configured to receive the assistance necessity level transmitted by the navigation assistance device.

(2)

The navigation assistance system according to (1), wherein
the transmitting unit of the navigation assistance device is further configured to transmit the navigation-related data at a particular frequency.

(3)

The navigation assistance system according to (2), wherein
the remote monitoring device further includes:
   a displaying unit configured to display the navigation-related data transmitted by the navigation assistance device;
   a generating unit configured to generate assistance data for assisting navigation of the ship in response to an operation input performed by a user; and
   a transmitting unit configured to transmit the assistance data to the navigation assistance device.

(4)

The navigation assistance system according to (2) or (3), wherein
the transmitting unit of the navigation assistance device is configured to change a frequency at which the navigation-related data is transmitted according to the assistance necessity level.

(5)

The navigation assistance system according to any one of (2) to (4), wherein
the transmitting unit of the navigation assistance device is configured to transmit, to the remote monitoring device, the navigation-related data that has not been transmitted in the past, in a case where communication at a particular speed or higher is established between the navigation assistance device and the remote monitoring device.

(6)

The navigation assistance system according to any one of (2) to (5), wherein
the remote monitoring device further includes:
   a calculating unit configured to calculate a relative assistance necessity level for multiple ships based on the navigation-related data transmitted from the multiple ships.

(7)

The navigation assistance system according to (6), wherein
the remote monitoring device further includes:
   a notifying unit configured to notify each of the multiple ships of the relative assistance necessity level.

(8)

The navigation assistance system according to any one (1) to (7), wherein
the remote monitoring device further includes:
   a displaying unit configured to display a symbol of the ship, and
the displaying unit is configured to change at least one of a display mode and a selected state of the symbol according to the assistance necessity level transmitted by the navigation assistance device.

(9)

A navigation assistance device including:
an acquiring unit configured to acquire navigation-related data related to navigation of a ship;
a calculating unit configured to calculate an assistance necessity level indicating a degree to which the ship requires assistance from outside, based on the navigation-related data; and
a transmitting unit configured to transmit the assistance necessity level to outside of the ship.

(10)

A navigation assistance method including:
acquiring navigation-related data related to navigation of a ship;
calculating an assistance necessity level indicating a degree to which the ship requires assistance from outside, based on the navigation-related data; and
transmitting the assistance necessity level to outside of the ship.

(11)

A program for causing a computer to execute processing configured to:
acquire navigation-related data related to navigation of a ship;
calculate an assistance necessity level indicating a degree to which the ship requires assistance from outside, based on the navigation-related data; and
transmit the assistance necessity level to outside of the ship.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A navigation assistance system comprising:
a navigation assistance device installed on a ship and comprising:
processing circuitry configured to:
acquire navigation-related data related to navigation of the ship;
calculate an assistance necessity level indicating a degree to which the ship requires assistance from outside, based on the navigation-related data; and
transmit the assistance necessity level to outside of the ship; and
a remote monitoring device installed outside the ship and comprising:
processing circuitry configured to receive the assistance necessity level transmitted by the navigation assistance device.

2. The navigation assistance system according to claim 1, wherein
the processing circuitry of the navigation assistance device is further configured to transmit the navigation-related data at a particular frequency.

3. The navigation assistance system according to claim 2, wherein
the processing circuitry of the remote monitoring device is further configured to:
display the navigation-related data transmitted by the navigation assistance device;
generate assistance data for assisting navigation of the ship in response to an operation input performed by a user; and
transmit the assistance data to the navigation assistance device.

4. The navigation assistance system according to claim 2, wherein
the processing circuitry of the navigation assistance device is configured to change a frequency at which the navigation-related data is transmitted according to the assistance necessity level.

5. The navigation assistance system according to claim 3, wherein
the processing circuitry of the navigation assistance device is configured to change a frequency at which the navigation-related data is transmitted according to the assistance necessity level.

6. The navigation assistance system according to claim 2, wherein
the processing circuitry of the navigation assistance device is configured to transmit, to the remote monitoring device, the navigation-related data that has not been transmitted in the past, in a case where communication at a particular speed or higher is established between the navigation assistance device and the remote monitoring device.

7. The navigation assistance system according to claim 3, wherein
the processing circuitry of the navigation assistance device is configured to transmit, to the remote monitoring device, the navigation-related data that has not been transmitted in the past, in a case where communication at a particular speed or higher is established between the navigation assistance device and the remote monitoring device.

8. The navigation assistance system according to claim 4, wherein
the processing circuitry of the navigation assistance device is configured to transmit, to the remote monitoring device, the navigation-related data that has not been transmitted in the past, in a case where communication at a particular speed or higher is established between the navigation assistance device and the remote monitoring device.

9. The navigation assistance system according to claim 5, wherein
the processing circuitry of the navigation assistance device is configured to transmit, to the remote monitoring device, the navigation-related data that has not been transmitted in the past, in a case where communication at a particular speed or higher is established between the navigation assistance device and the remote monitoring device.

10. The navigation assistance system according to claim 2, wherein
the processing circuitry of the remote monitoring device is further configured to:
calculate a relative assistance necessity level for a plurality of ships based on the navigation-related data transmitted from the plurality of ships.

11. The navigation assistance system according to claim 9, wherein
the processing circuitry of the remote monitoring device is further configured to:
calculate a relative assistance necessity level for a plurality of ships based on the navigation-related data transmitted from the plurality of ships.

12. The navigation assistance system according to claim 10, wherein
the processing circuitry of the remote monitoring device is further configured to:
notify each of the plurality of ships of the relative assistance necessity level.

13. The navigation assistance system according to claim 1, wherein
the processing circuitry of the remote monitoring device is further configured to:
display a symbol of the ship, and
the processing circuitry of the remote monitoring device is configured to change at least one of a display mode and a selected state of the symbol according to the assistance necessity level transmitted by the navigation assistance device.

14. The navigation assistance system according to claim 3, wherein
the processing circuitry of the remote monitoring device is further configured to:
display a symbol of the ship, and
the processing circuitry of the remote monitoring device is configured to change at least one of a display mode and a selected state of the symbol according to the assistance necessity level transmitted by the navigation assistance device.

15. The navigation assistance system according to claim 5, wherein
the processing circuitry of the remote monitoring device is further configured to:
display a symbol of the ship, and
the processing circuitry of the remote monitoring device is configured to change at least one of a display mode and a selected state of the symbol according to the assistance necessity level transmitted by the navigation assistance device.

16. The navigation assistance system according to claim 9, wherein
the processing circuitry of the remote monitoring device is further configured to:
display a symbol of the ship, and
the processing circuitry of the remote monitoring device is configured to change at least one of a display mode and a selected state of the symbol according to the assistance necessity level transmitted by the navigation assistance device.

17. The navigation assistance system according to claim 11, wherein
the processing circuitry of the remote monitoring device is further configured to:
display a symbol of the ship, and
the processing circuitry of the remote monitoring device is configured to change at least one of a display mode and a selected state of the symbol according to the assistance necessity level transmitted by the navigation assistance device.

18. The navigation assistance system according to claim 12, wherein
the processing circuitry of the remote monitoring device is further configured to:
display a symbol of the ship, and
the processing circuitry of the remote monitoring device is configured to change at least one of a display mode and a selected state of the symbol according to the assistance necessity level transmitted by the navigation assistance device.

19. A navigation assistance device comprising:
processing circuitry configured to:
acquire navigation-related data related to navigation of a ship;
calculate an assistance necessity level indicating a degree to which the ship requires assistance from outside, based on the navigation-related data; and
transmit the assistance necessity level to outside of the ship.

20. A navigation assistance method comprising:
acquiring navigation-related data related to navigation of a ship;
calculating an assistance necessity level indicating a degree to which the ship requires assistance from outside, based on the navigation-related data; and
transmitting the assistance necessity level to outside of the ship.
